(19) United States
(12) Patent Application Publication
(10) Pub. No.: US 2016/0156952 A1
(43) Pub. Date: Jun. 2, 2016

(54) SYSTEM, METHOD, AND COMPUTER PROGRAM PRODUCT

(71) Applicants: KABUSHIKI KAISHA TOSHIBA, Tokyo (JP); Toshiba Lifestyle Products & Services Corporation, Tokyo (JP)

(72) Inventors: Motonobu SUGIURA, Ome Tokyo (JP); Masaaki KIKUCHI, Akishima Tokyo (JP); Hiroshi HATTORI, Akishima Tokyo (JP); Yoshihiro OHMORI, Ome Tokyo (JP); Hideo KATAOKA, Nerima Tokyo (JP); Sougo TSUBOI, Kawasaki Kanagawa (JP)

(21) Appl. No.: 14/923,181

(22) Filed: Oct. 26, 2015

(30) Foreign Application Priority Data
Nov. 28, 2014 (JP) 2014-242151

(51) Int. Cl. H04N 21/25; H04N 21/4147; H04N 21/45; H04N 21/2187; G06Q 30/02; H04N 21/466

(52) U.S. Cl. CPC H04N 21/252; G06Q 30/0201; H04N 21/4667; H04N 21/4532; H04N 21/2187; H04N 21/4147

(57) ABSTRACT

According to one embodiment, a system includes a hardware processor, wherein the hardware processor is configured to receive first viewing information relating to viewing a first content item by a set of users, second viewing information relating to viewing a second content item by the set of users, and action information relating to actions performed by at least some of the set of users, and to output information relating to a viewing condition of the first content item and information relating to a viewing condition of the second content item based on a first action by a plurality of users from the set of users, the plurality of users set as a statistical population when the first action is designated.

### CROSS-REFERENCE TO RELATED APPLICATIONS

This application is based upon and claims the benefit of priority from Japanese Patent Application No. 2014-242151, filed Nov. 28, 2014, the entire contents of which are incorporated herein by reference.

### FIELD

Embodiments described herein relate generally to a system, a method, and a computer program product.

### BACKGROUND

In recent years, viewing information such as a television viewing rating has been analyzed as one of big data analyses. Results provided by the analysis can be utilized in various fields.

In the conventional technique, when an advertisement is distributed on contents like television programs, it is desired that an effect on actions of viewers of the contents is analyzed.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an example of the network configuration of a viewing system according to a first embodiment;

FIG. 2 is an exemplary block diagram illustrating an example of the hardware configuration of a server and an electronic device in the first embodiment;

FIG. 3 is an exemplary block diagram illustrating the functional configuration of the server in the first embodiment;

FIG. 4 is an exemplary block diagram illustrating the functional configuration of the electronic device in the first embodiment;

FIG. 5 is an exemplary diagram illustrating an example of a data structure of tabulated result data in the first embodiment;

FIG. 6 is an exemplary flowchart illustrating an example of procedures of display processing in the first embodiment;

FIG. 7 is an exemplary diagram illustrating an example of display of viewing data in a program listing format in the first embodiment;

FIG. 8 is an exemplary diagram illustrating an example of display of viewing data according to a modification of the first embodiment;

FIG. 9 is an exemplary diagram illustrating an example of display of the viewing data in the modification of the first embodiment;

FIG. 10 is an exemplary diagram illustrating an example of display of viewing data according to a second embodiment;

FIG. 11 is an exemplary diagram illustrating another example of display of the viewing data in the second embodiment;

FIG. 12 is an exemplary diagram illustrating an example of display of viewing data according to a third embodiment;

FIG. 13 is an exemplary diagram illustrating an example of a user interface according to a fourth embodiment;

FIG. 14 is an exemplary diagram illustrating an example of display of viewing data according to a fifth embodiment; and

FIG. 15 is an exemplary diagram illustrating an example of display of viewing data according to a sixth embodiment.

### DETAILED DESCRIPTION

In general, according to one embodiment, a system comprises a hardware processor, wherein the hardware processor is configured to receive first viewing information relating to viewing a first content item by a set of users, second viewing information relating to viewing a second content item by the set of users, and action information relating to actions performed by at least some of the set of users, and to output information relating to a viewing condition of the first content item and information relating to a viewing condition of the second content item based on a first action by a plurality of users from the set of users, the plurality of users set as a statistical population when the first action is designated.

Hereinafter, embodiments will be described.

### First Embodiment

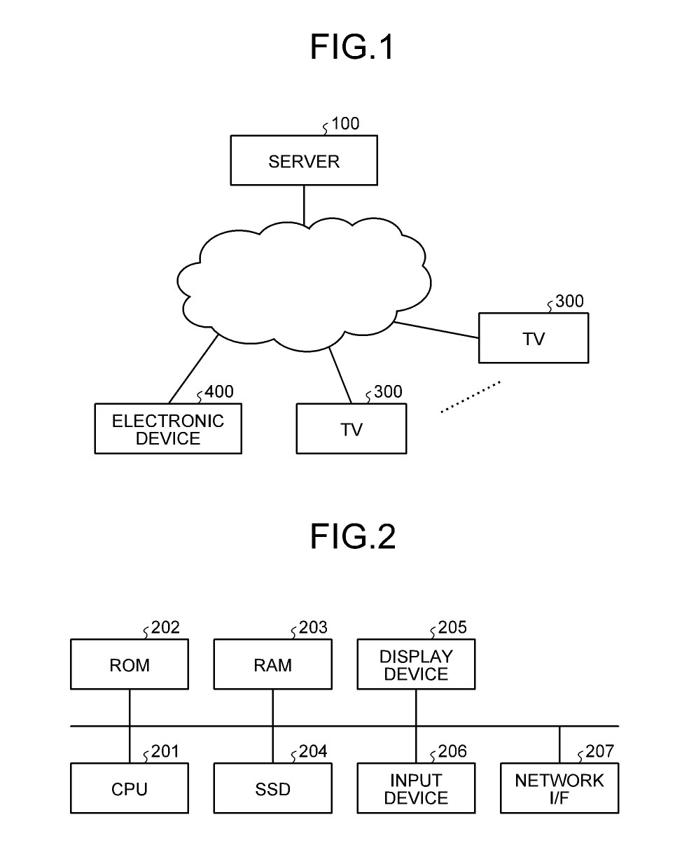

FIG. 1 is a diagram illustrating an example of the network configuration of a viewing system according to a first embodiment. As illustrated in FIG. 1, the viewing system in the first embodiment comprises a server 100 on a cloud, an electronic device 400 capable of being connected to the server 100 through a network such as the Internet, and a plurality of televisions (TVs) 300.

The server 100 collects and tabulates viewing histories of viewers and pieces of action information of the viewers for broadcasted program contents from the TVs 300 and transmits a tabulation result to the electronic device 400. The electronic device 400 receives the tabulation result from the server 100 and displays viewing information such as a viewing rating for each piece of action information of the viewers.

FIG. 2 is a block diagram illustrating an example of the hardware configurations of the server 100 and the electronic device 400 in the first embodiment. As illustrated in FIG. 2, the server 100 and the electronic device 400 in the first embodiment have the same hardware configuration and mainly comprise a central processing unit (CPU) 201, a read only memory (ROM) 202, a random access memory (RAM) 203, a solid state drive (SSD) 204, a network interface (I/F) 207, an input device 206 such as a keyboard and a mouse, and a display device 205 such as a display.

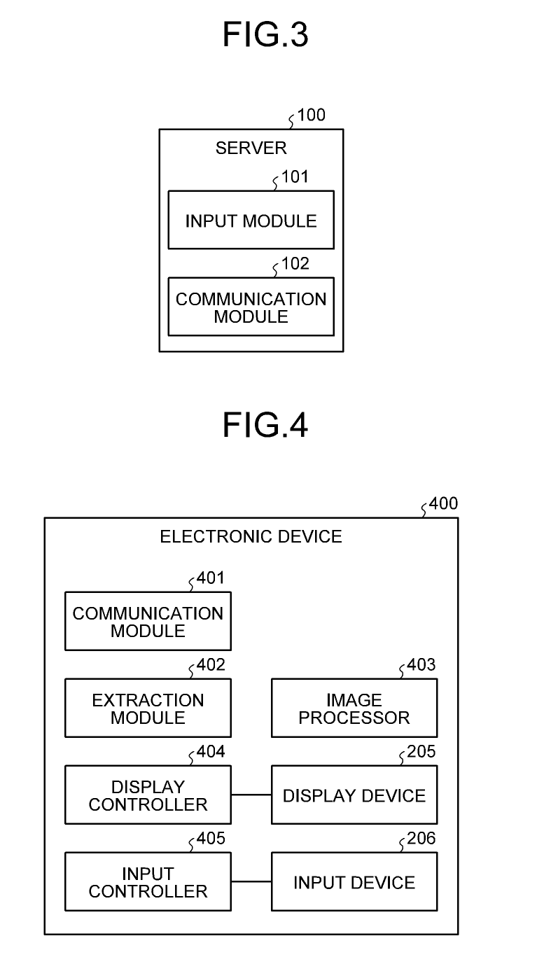

FIG. 3 is a block diagram illustrating the functional configuration of the server 100 in the first embodiment. As illustrated in FIG. 3, the server 100 in the first embodiment mainly comprises a communication module 102 and an input module 101.

The communication module 102 controls communication with the TVs 300 and the electronic device 400. The input module 101 receives input of pieces of viewing information related to viewing conditions of the broadcasted program contents by respective viewers from the TVs 300 and the like. In the first embodiment, the pieces of viewing information related to viewing of the program content are input to the input module 101 for each program content (for example, a first program content or a second program content).

The viewing information related to the viewing condition of the content by each viewer (user) may be any information as long as the information relates to a viewing condition, such as information indicating whether each viewer has viewed the content provided by broadcasting through a television (for example, digital terrestrial broadcasting), broadcasting satellite (BS), communication satellite (CS), or the like, a moving image distribution service such as video on demand (VOD), or the like, information indicating a ratio of the content viewed by each viewer, information indicating whether each viewer has viewed the content at least temporarily.

The input module 101 receives input of action information related to action made by each viewer from a predetermined external medium or the like. The input module 101 tabulates the collected viewing histories and pieces of action information. To be specific, the input module 101 generates, as tabulated result data, the viewing information containing an overall viewing rating and viewing ratings for individual pieces of action information based on the collected viewing histories and pieces of action information. The communication module 102 transmits the tabulated result data to the electronic device 400.

The action information in the first embodiment indicates action that is made by the viewer of the program content. For example, the action information is any one or more among purchase information indicating that a predetermined product is purchased, usage information indicating that provision of a predetermined service is received, browsing information indicating that a predetermined WEB site is browsed or used, and movement information indicating that a viewer moves to or stays at a predetermined area, but is not limited thereto. The movement indicates that the viewer is present in the predetermined area at least at a moment and stay indicates that the viewer is present in the predetermined area for at least a predetermined period of time (for example, one day) or longer.

Furthermore, the action information in the first embodiment may indicate other action made by the viewer. For example, the action information may be any one or more among viewing a predetermined content, viewing a plurality of contents of the same series, and viewing the same content for a plurality of times. It is considered that the series is of dramas, movies, variety programs, or commercials (CM), for example.

The viewing of the predetermined content indicates that the viewer has viewed a 60-minute program for equal to or longer than 45 minutes, for example. It should be noted that fast-forward periods and the like are excluded in calculation of the viewing time.

The viewing the plurality of contents of the same series indicates that the viewer has viewed eight or more stories out of thirteen stories of one season, for example. Furthermore, the viewing the plurality of contents of the same series indicates that the viewer has viewed two or more pieces of a trilogy of movies, for example.

The viewing the same content for the plurality of times indicates the followings, for example. That is, the viewer has viewed a program that is broadcasted once per week for years for thirty or more times. Furthermore, it is expected that the viewer has viewed a CM of the same series for at least three times.

FIG. 4 is a block diagram illustrating the functional configuration of the electronic device 400 in the first embodiment. As illustrated in FIG. 4, the electronic device 400 in the first embodiment mainly comprises a communication module 401, an extraction module 402, an image processor 403, a display controller 404, an input controller 405, the above-mentioned display device 205, and the above-mentioned input device 206.

The communication module 401 controls communication with the server 100 and the like. In the first embodiment, the communication module 401 receives the tabulated result data tabulated by the server 100.

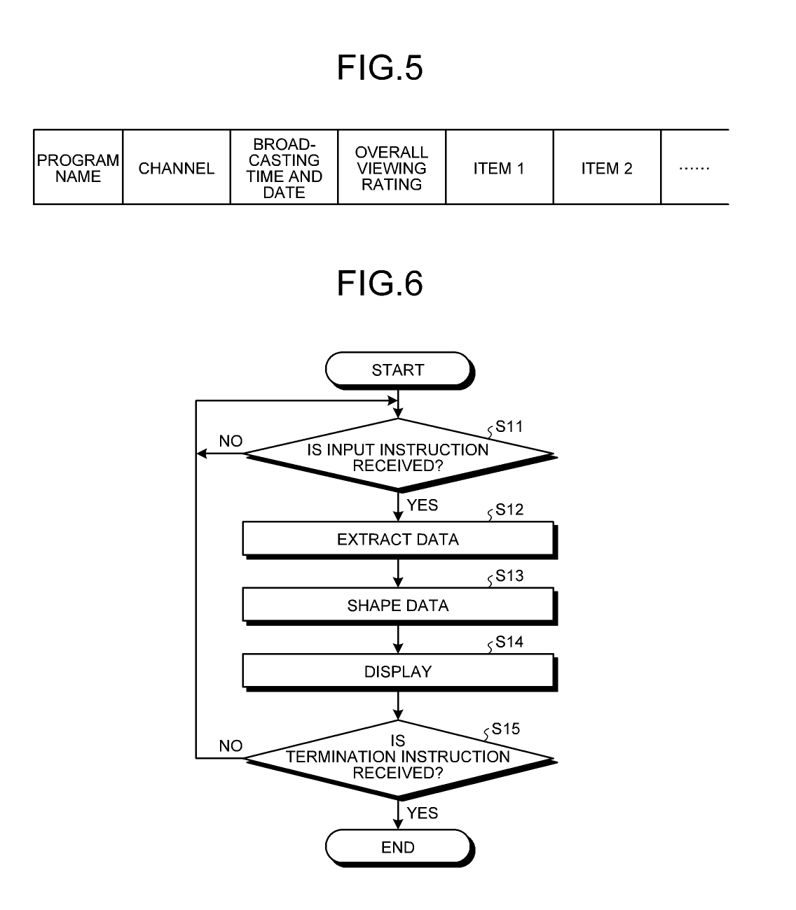

FIG. 5 is a diagram illustrating an example of a data structure of the tabulated result data in the first embodiment. As illustrated in FIG. 5, the tabulated result data in the first embodiment contains a program name, a channel, a broadcasting time and date, an overall viewing rating, an item 1, an item 2, and the like. The program name is a name of a program content viewed by the viewers. The channel is a channel on which the program content is broadcasted. The broadcasting time and date is a date and time that the program content of the program name is broadcasted. The overall viewing rating is a viewing rating when the program content of the program name is not narrowed down by the action information. The item 1, the item 2, and the like are individual viewing ratings, the number of viewers, or the like for the respective pieces of action information.

The extraction module 402 extracts the viewing information, such as the viewing rating, concerning action information designated by the user through the input device 206, from the tabulated result data received from the server 100.

The image processor 403 shapes the tabulated result data or extracted data extracted from the tabulated result data by the extraction module 402 into a display format to be displayed on the display device 205 and performs various kinds of image processing. To be specific, in the first embodiment, the image processor 403 shapes the extracted data into a predetermined display format such as a program listing format and processes the data into an image indicating the viewing ratings of the respective program contents expressed by shading.

The display controller 404 performs display control on the display device 205. In the first embodiment, the display controller 404 displays, on the display device 205, the tabulated result data or the extracted data having undergone shaping or image processing in the image processor 403.

The input controller 405 controls input through the input device 206. In the first embodiment, the input controller 405 receives input of selection of the action information designated by the user through the input device 206.

Next, display processing by the electronic device 400 in the first embodiment that is thus configured will be described. FIG. 6 is a flowchart illustrating an example of procedures of the display processing in the first embodiment. It is assumed that the electronic device 400 has already received the tabulated result data as illustrated in FIG. 5 from the server 100. Furthermore, it is assumed that in the electronic device 400, the image processor 403 shapes the received tabulated result data into the program listing format and performs image processing on it into a format (what-is-called heat map format) in which the viewing ratings are expressed by shading so as to provide viewing data in the program listing format and the display controller 404 displays the viewing data in the program listing format on the display device 205.

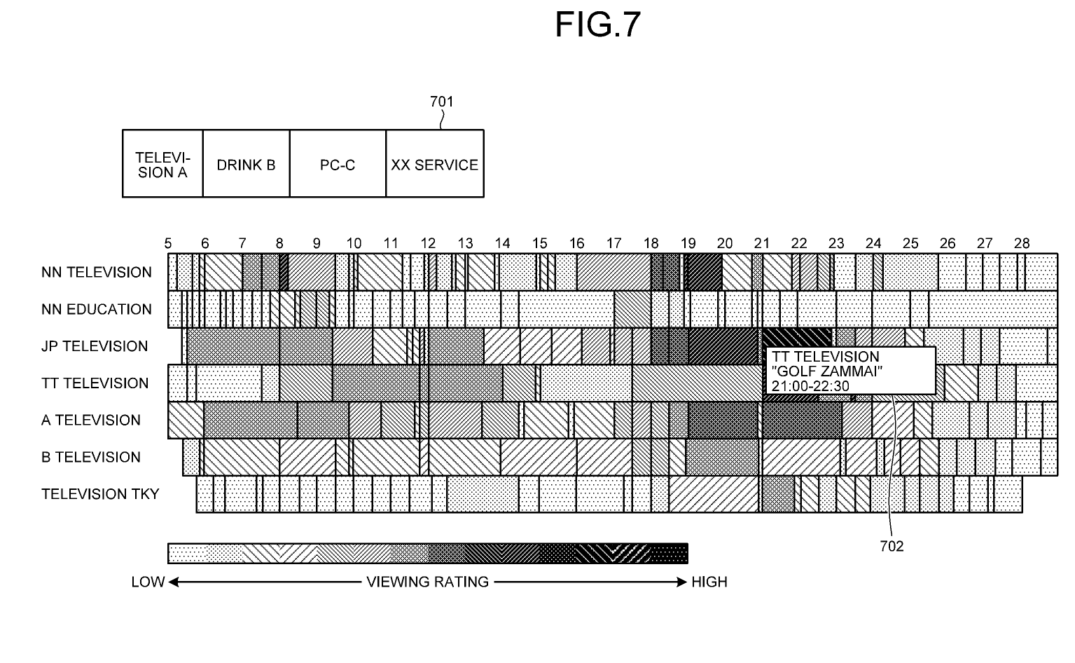

FIG. 7 is a diagram illustrating an example of display of the viewing data in the program listing format in the first embodiment. As illustrated in FIG. 7, the viewing data is provided such that the viewing ratings of program contents for respective channels are expressed by the shaded rectangles indicating broadcast time bands of the program contents at the center. As the shade of the rectangle is thicker, the viewing rating is higher whereas as the shade of the rectangle is thinner, the viewing rating is lower. Before the processing as illustrated in the flowchart of FIG. 6 is executed, the viewing ratings in the viewing data in the program listing format as illustrated in FIG. 7 indicate the overall viewing ratings. In FIG. 7, a reference numeral 702 indicates detail information of a desired program that is displayed when the program is selected on the program listing.

As illustrated in FIG. 7, a selection button 701 for selecting the action information is displayed in an upper left portion of a display field of the viewing data. The pieces of action information as illustrated in FIG. 7 include purchase information of a television A, purchase information of a drink B, purchase information of a PC-C, and usage information of an XX service. It should be noted that they are merely examples and the pieces of action information and the selection button 701 are not limited thereto.

With reference back to FIG. 6, an input waiting state is established in a state where the screen of FIG. 7 is displayed (No at S11). When a user designates desired action information with the selection button 701 for selecting the action information through the input device 206 (Yes at S11), the extraction module 402 extracts the viewing ratings for the selected action information from the tabulated result data (S12). Then, the image processor 403 shapes the extracted data into the program listing format and performs the image processing on it into the format in which the viewing ratings are expressed by shading so as to provide the viewing data in the program listing format (S13). Then, the display controller 404 displays the viewing data corresponding to the selected action information in the program listing format on the display device 205 (S14).

For example, when the user designates the “drink B” with the selection button for selecting the action information, the display controller 404 switches the screen and displays information related to a viewing condition for each program content (for example, information related to the viewing condition of the first program content or information related to the viewing condition of the second program content) while the viewers that have purchased the drink B are set as population among all the viewers (at least a plurality of viewers).

The information related to the viewing condition for the content while the plurality of viewers are set as the population may be any information as long as it relates to a condition where the content provided by broadcasting through the television (digital terrestrial broadcasting), the broadcasting satellite (BS), the communication satellite (CS), or the like, a moving image distribution service such as video on demand (VOD), or the like is viewed by all the viewers or a part of the viewers narrowed down under a certain condition (population). For example, the information related to the viewing condition for the content while the plurality of viewers are set as the population include a cumulative value, time change, and the like of viewing ratings, the number of viewing persons, the number of times of viewing, and the like.

Furthermore, other examples of the information related to the viewing condition for the program content include information indicating whether the program content has been viewed live during broadcasting and information indicating whether the program content has been recorded and viewed after broadcasted live.

Then, the input controller 405 determines whether it receives input of a termination instruction from the user (S15). When the input controller 405 receives the termination instruction (Yes at S15), the processing is finished. On the other hand, when the input controller 405 does not receive the termination instruction (No at S15), the process returns to S11 and a state of waiting for input from the user is established. When the user inputs further selection switchover of the action information or another condition to further narrow down the population (see the following modification and the like), it is performed after the process returns to S11 from S15.

In the first embodiment, on the display of the viewing ratings of the program contents, the viewing ratings while the viewers with the action information selected by the user are set as the population are visually displayed, whereby an effect on the actions of the viewers of the program contents can be analyzed.

### Modification

The action information is not limited to the above-mentioned example. For example, information of a booking applicant of a predetermined product, information related to viewing music or video on demand (VOD), or information indicating a user of a specific application, Hybrid cast, or data broadcasting can be used as the action information.

Although the viewing information has been described using the viewing rating as an example, the viewing information is not limited thereto. For example, in addition to the viewing rating of the program content, the number of viewings, the number of purchases, the number of usages of the service, the number of viewings of music or VOD, the number of browsing times of a homepage, or the like can be used as an indicator of the viewing information.

Although the action information such as the purchase information is used as the extraction condition of the population at S12 in the first embodiment, clusters can be generated with groups having similar tendencies based on age brackets, family structures, devices used, and viewing histories or reservations of programs and a combination of the action information and the clusters can be used as the extraction condition.

In addition to display of the viewing information of the tabulation result for each piece of action information designated by the user, a plurality of conditions may be aligned to be displayed so as to enable the user to further narrow down the population.

Although the viewing data is displayed in the heat map format as illustrated in FIG. 7 in the first embodiment, the viewing data is not limited thereto. For example, the image processor 403 can be configured so as to display the viewing information such as the viewing rating using a line graph, an area, a symbol, or the like.

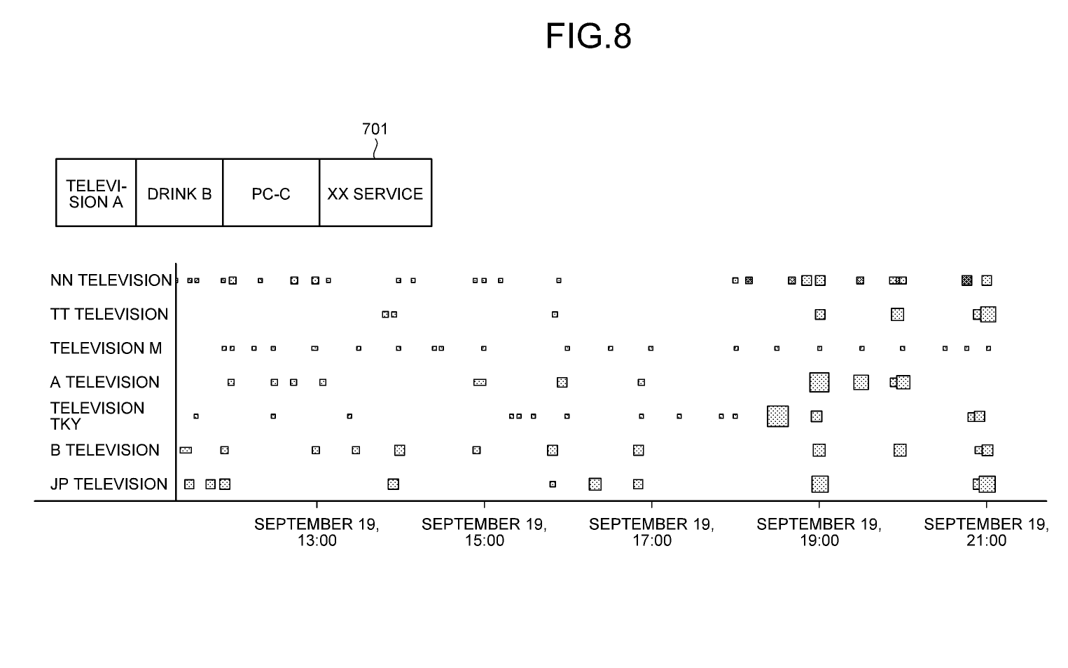

As illustrated in FIG. 8, the image processor 403 and the display controller 404 can be configured so as to display the pieces of viewing information using a plurality of different indicators including the area (size), the color, and the like of the rectangles at the same time. In a display example in FIG. 8, for example, the image processor 403 and the display controller 404 can be configured such that the levels of the viewing ratings are expressed by the areas of the rectangles, rectangles of a first color indicate the overall viewing ratings, and rectangles of a second color indicate viewing ratings by the viewers with the action information selected by the selection button 701. Furthermore, the image processor 403 and the display controller 404 may be configured so as to display the pieces of viewing information of the program contents and indicate different indicators with shapes other than rectangle.

The image processor 403 and the display controller 404 maybe configured such that the number of viewings is tabulated for each of viewing types including live viewing (viewing of a content broadcasted live) and video-recording viewing (viewing of a recorded content) and the number of viewings of each of the live viewing and the video-recording viewing are displayed at the same time for each piece of action information when the number of viewings is used as the viewing information. In this case, the viewing types need to be set as the items in the tabulated result data as illustrated in FIG. 5.

Furthermore, the extraction module 402 can be configured so as to narrow down the population by a ratio of the viewing of the program content as the number of viewings. In this case, the viewing ratio for each viewer needs to be set as the item in the tabulated result data as illustrated in FIG. 5.

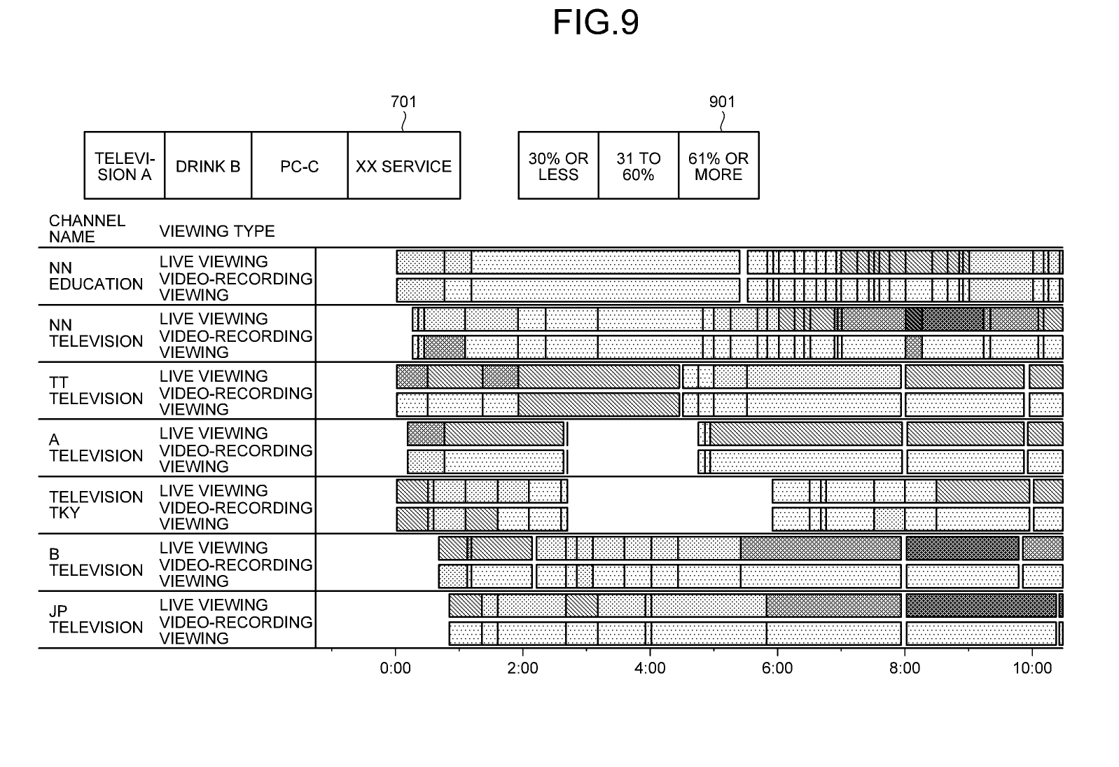

FIG. 9 illustrates an example where the number of viewings is tabulated for each viewing mode, the number of viewings of each of the live viewing and the video-recording viewing as the viewing types are displayed at the same time for each piece of action information, and the viewing ratio is caused to be selected by the user for display. In the display example as illustrated in FIG. 9, the number of viewings of each of the live viewing and the video-recording viewing as the viewing types are displayed at the same time and a selection button 901 for selecting the viewing ratio is displayed in an upper right portion. In the example of FIG. 9, any one of 30% or less, 31 to 60%, and 61% or more can be selected as the viewing ratio. When the user selects the action information and selects the viewing ratio, input instructions of the selections are received at S11 in FIG. 6 and the display controller 404 displays the number of viewings of each of the live viewing and the video-recording viewing of the program contents viewed by the viewers with the selected action information at the selected viewing ratio on the display device 205 at the same time.

### Second Embodiment

In a second embodiment, instead of tabulating the program contents in the first embodiment, tabulation based on a preset unit such as day and time or tabulation based on a scene or a CM is performed and tabulated results are displayed on the electronic device 400. The network configuration, and the hardware configurations and the functional configurations of the server 100 and the electronic device 400 in the second embodiment are same as those in the first embodiment.

In the second embodiment, the input module 101 of the server 100 collects ages of the viewers and tabulates the number of viewings or the viewing rating for each generation, day, and time. The input module 101 sets the number of viewings or the viewing rating for each generation, day, or time to the item as the tabulated result data and transmits it to the electronic device 400.

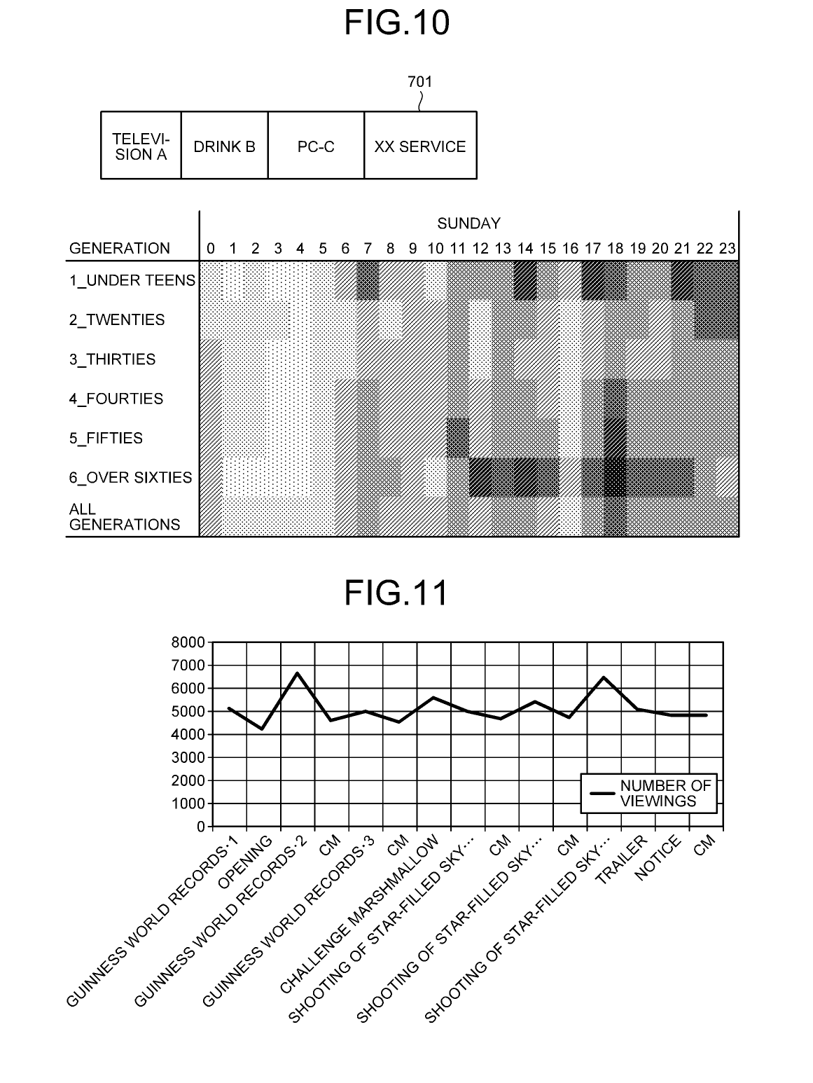

In the electronic device 400, the image processor 403 performs shaping and image processing on the received tabulated result data and the display controller 404 displays it on the display device 205 as in the first embodiment. FIG. 10 is a diagram illustrating a display example of viewing data in the second embodiment. Also in FIG. 10, the levels of the viewing ratings are expressed by the shaded rectangles. As illustrated in FIG. 10, the viewing rating based on the day and time for each generation is displayed. On the screen as illustrated in FIG. 10, when the user selects desired action information by the selection button 701 for selecting the action information in the upper left portion, the extraction module 402 extracts data of the selected action information from the tabulated result data at S12 in FIG. 6, the image processor 403 shapes the extracted data and performs image processing on it at S13, and the display controller 404 displays the extracted data on the display device 205 at S14 as in the first embodiment. As a result, the viewing rating related to the selected action information based on the day and time for each respective generation is displayed.

In the second embodiment, in the server 100, the input module 101 collects and tabulates pieces of viewing information (viewing ratings or the number of viewings) of scenes and CMs constituting a program content in addition to the viewing information of the program content. The input module 101 sets the pieces of viewing information of the plurality of scenes and CMs for one program name of the program content in the items as the tabulated result data and transmits it to the electronic device 400.

In the electronic device 400, the image processor 403 performs the shaping and the image processing on the received tabulated result data and the display controller 404 displays it on the display device 205 as in the first embodiment. FIG. 11 is a diagram illustrating another display example of the viewing data in the second embodiment. FIG. 11 illustrates the viewing data with a line graph indicating the number of viewings as the viewing information. As illustrated in FIG. 11, the number of viewings for the respective scenes and CMs are displayed. On the screen as illustrated in FIG. 10, when the user selects desired action information by the selection button 701 for selecting the action information in the upper left portion, the extraction module 402 extracts data of the selected action information from the tabulated result data at S12 in FIG. 6, the image processor 403 shapes the extracted data and performs the image processing on it at S13, and the display controller 404 displays the extracted data on the display device 205 at S14 as in the first embodiment. As a result, the number of viewings related to the selected action information for the respective scenes and CMs are displayed.

In the second embodiment, the electronic device 400 performs tabulation based on a preset unit such as day and time or tabulation based on a scene and a CM and displays the viewing information on the electronic device 400, whereby an effect on the actions of the viewers of the contents can be analyzed.

### Modification

The input module 101, the extraction module 402, the image processor 403, and the display controller 404 may be configured such that extraction and tabulation are performed while narrowing down the number of viewings or the viewing rating of the program content or the scene to the number of viewings or the viewing rating of a specific scene such as a live scene, a score scene in a sport, and a scene with an entertainer designated by the user, a selected CM, a CM related to a specific genre such as a soft-drink CM and a CD CM, and the entire CMs, and the viewing data is displayed. In this case, for example, the number of viewings, as illustrated in FIG. 10, for the above-mentioned specific scene or specific CM corresponds to that for the scene for each piece of action information.

### Third Embodiment

In a third embodiment, differences between an average for all generations of the viewers and averages for individual generations are tabulated and viewing data is displayed based on the differences from other sections. The network configuration, and the hardware configurations and the functional configurations of the server 100 and the electronic device 400 in the third embodiment are the same as those in the first embodiment.

In the third embodiment, in the server 100, the input module 101 collects ages of the viewers that constitute the population, calculates and tabulates an average value (for example, average value of the number of viewings) related to the viewing conditions for all the generations, average values (for example, average values of the number of viewings) related to the viewing conditions for individual generations as a part of the population, and differences between the average values. Then, the input module 101 sets the differences between the average value related to the viewing conditions for all the generations (for example, the average value of the number of viewings) and the average values related to the viewing conditions for the individual generations (for example, the average values of the number of viewings) in the items as the tabulated result data, and transmits it to the electronic device 400.

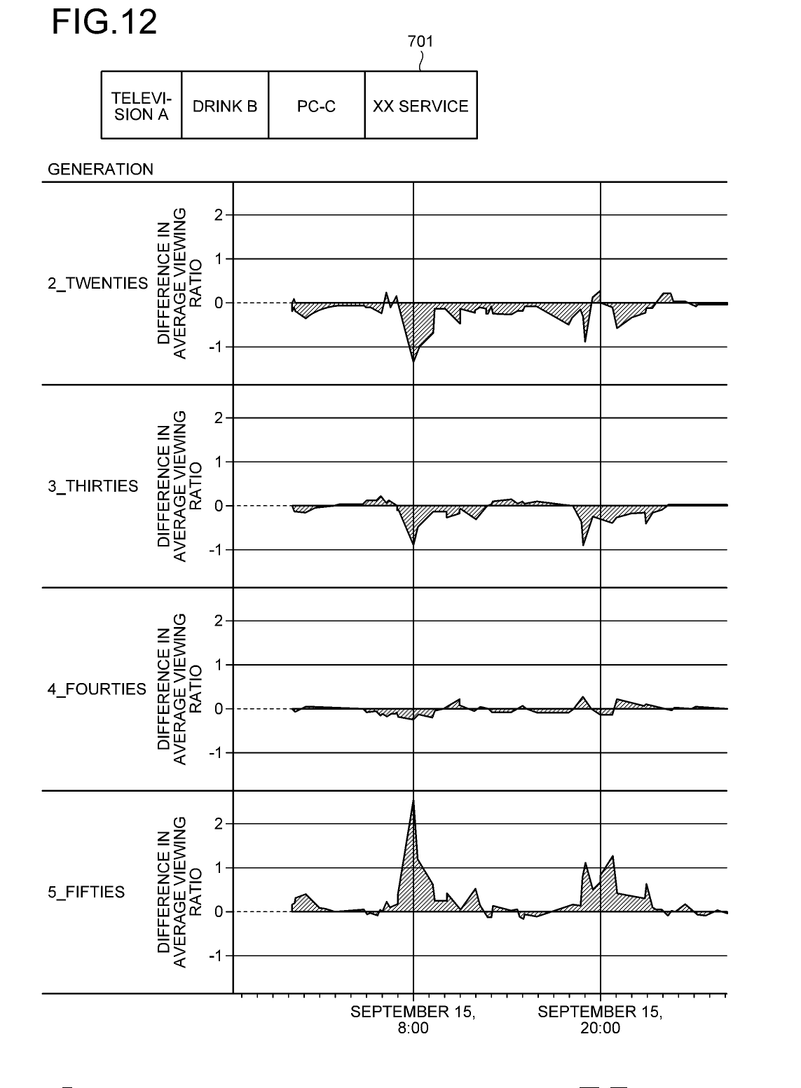

In the electronic device 400, the image processor 403 performs the shaping and the image processing on the received tabulated result data and the display controller 404 displays it on the display device 205 as in the first embodiment. FIG. 12 is a diagram illustrating a display example of the viewing data in the third embodiment. In FIG. 12, the difference between the average value of the number of viewings for all the generations and the average values of the number of viewings for the individual generations is displayed for each generation.

On the screen as illustrated in FIG. 12, when the user selects desired action information by the selection button 701 for selecting the action information in the upper left portion, the extraction module 402 extracts data of the selected action information from the tabulated result data at S12 in FIG. 6, the image processor 403 shapes the extracted data and performs the image processing on it at S13, and the display controller 404 displays the extracted data on the display device 205 at S14 as in the first embodiment. As a result, the differences between the average value of the number of viewings for all the generations and the average values of the number of viewings for the individual generations are displayed for the respective generations related to the selected action information.

In the third embodiment, the differences between the average value for all the generations of the viewers and the average values for the respective generations are tabulated and the viewing data is displayed based on the differences relative to other sections, whereby an effect on the actions of the viewers of the contents can be analyzed more in detail.

### Modification

The input module 101, the extraction module 402, the image processor 403, and the display controller 404 may be configured such that instead of the viewing information, the number of times of broadcasting CM, performance information of an entertainer, and broadcasting on a local station are allocated and they are tabulated and displayed in combination with program information such as the number of broadcasting stations in the local areas. For example, in the example of FIG. 7, the shading of rectangles can be changed for display based on the number of CMs, the number of times of performance of a specific entertainer or a specific group, information indicating whether the program is broadcasted by the nationwide network or broadcasted in partial areas, and the like.

### Fourth Embodiment

In a fourth embodiment, for example, the input module 101, the extraction module 402, the image processor 403, and the display controller 404 are configured as follows. That is, before display of FIG. 7, a national map is displayed and pieces of viewing information of program contents that are broadcasted in an area selected through the input device 206 by the user are tabulated on the national map and are displayed on the display device 205. Other configurations thereof are the same as those in the first embodiment.

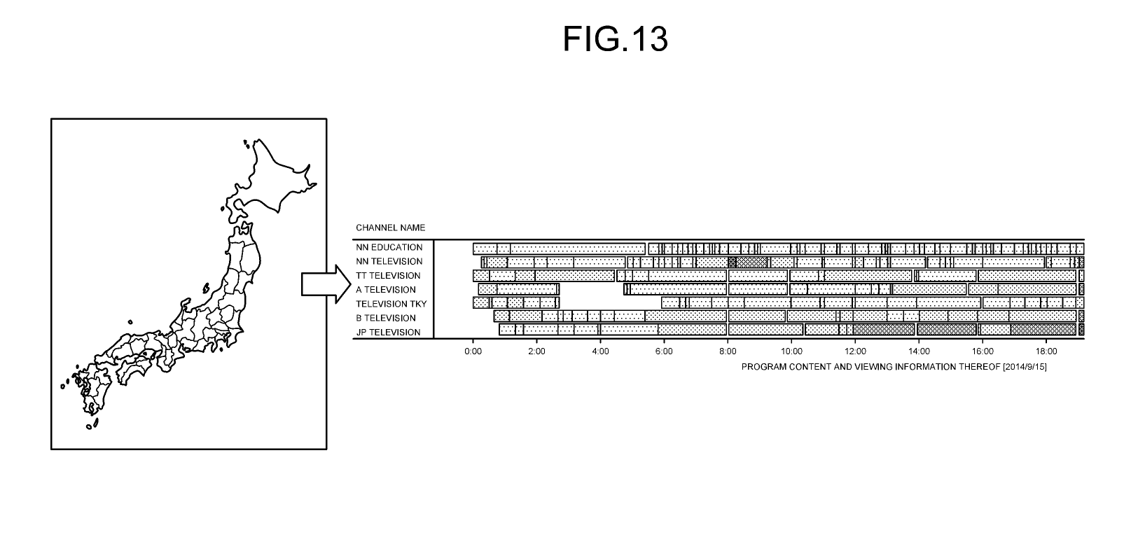

FIG. 13 is a diagram illustrating an example of a user interface. When the user selects a desired area on the national map on the left side, the extraction module 402 extracts program contents that are broadcasted in the area selected by the user and the pieces of viewing information thereof from the tabulated result data. Then, as illustrated in a right view of FIG. 13, the extracted program contents and the pieces of viewing information thereof are displayed.

In the fourth embodiment, the pieces of viewing information of the program contents that are broadcasted on the area selected by the user are tabulated and displayed on the display device 205, whereby an effect on the actions of the viewers of the contents can be analyzed more in detail.

Furthermore, in addition to the action information, the input device 206 may receive designation of an area. When the area is designated through the input device 206 in addition to the action information, the display controller 404 displays, as at least one of pieces of information related to the viewing conditions of a plurality of program contents that are displayed on the display device 205 (for example, information related to the viewing condition of a first content or information related to the viewing condition of a second content), the number of viewings on the designated area by, for example, viewers that have made the designated action as information of viewing conditions by the viewers corresponding to the designated area.

### Fifth Embodiment

In a fifth embodiment, when a user designates a specific program content on a display screen of viewing information, different stories of the program content same as the selected program content, rebroadcasting thereof, and the same programs that are broadcasted in different areas are tabulated and extracted for each area and a tabulation result related to programs similar to the selected program is displayed.

For example, it is assumed that the user designates a rectangle of a specific program content through the input device 206 on the display screen of the viewing information for each piece of action information as illustrated in FIG. 7. In this case, the extraction module 402 extracts different stories of the program content same as the program content of the rectangle designated by the user, rebroadcasting thereof, and the same programs that are broadcasted in different areas for each area from the tabulated result data at S12 in FIG. 6.

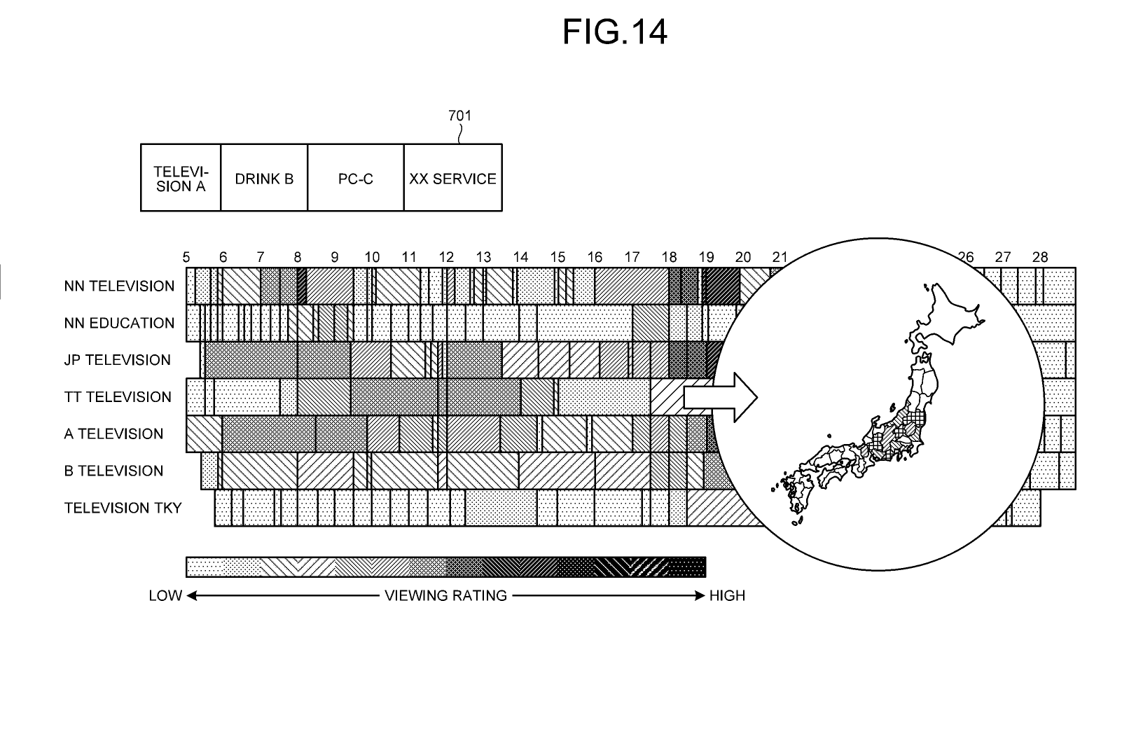

Then, the image processor 403 shapes the extracted data and performs the image processing on it at S13 in FIG. 6, and the display controller 404 displays the extracted data on the display device 205 at S14. As a result, as illustrated in FIG. 14, pieces of viewing information indicating different stories of the program content same as the program content of the rectangle designated by the user, the rebroadcasting thereof, and the same programs that are broadcasted in different areas are displayed for each area. In the example of FIG. 14, the levels of the viewing ratings of the different stories of the program content same as the program content of the rectangle designated by the user, the rebroadcasting thereof, and the same programs that are broadcasted in different areas are expressed by shading of color on prefectures of the national map. It should be noted that a display mode is not limited thereto.

In the fifth embodiment, when the user designates a specific program content on the display screen of the viewing information, different stories of the program content same as the selected program content, the rebroadcasting thereof, and the same programs that are broadcasted in different areas are tabulated and extracted for each area and the tabulation result related to the programs similar to the selected program are displayed. The fifth embodiment, therefore, enables an effect on the actions of the viewers of the program content to be analyzed more in detail.

### Sixth Embodiment

In a sixth embodiment, when a user designates a specific program content on a display screen of viewing information, viewing information related to a selected program content is displayed based on any time section such as a scene contained in the selected program content or a second.

As in the second embodiment, the server 100 transmits the tabulated result data containing the viewing information related to scenes and CMs contained in the program content to the electronic device 400.

For example, it is assumed that the user designates a rectangle of a specific program content through the input device 206 on the display screen of the viewing information for each piece of action information as illustrated in FIG. 7 on the electronic device 400. In this case, the extraction module 402 extracts pieces of viewing information based on a scene contained in the program content of the rectangle designated by the user or a second from the tabulated result data at S12 in FIG. 6.

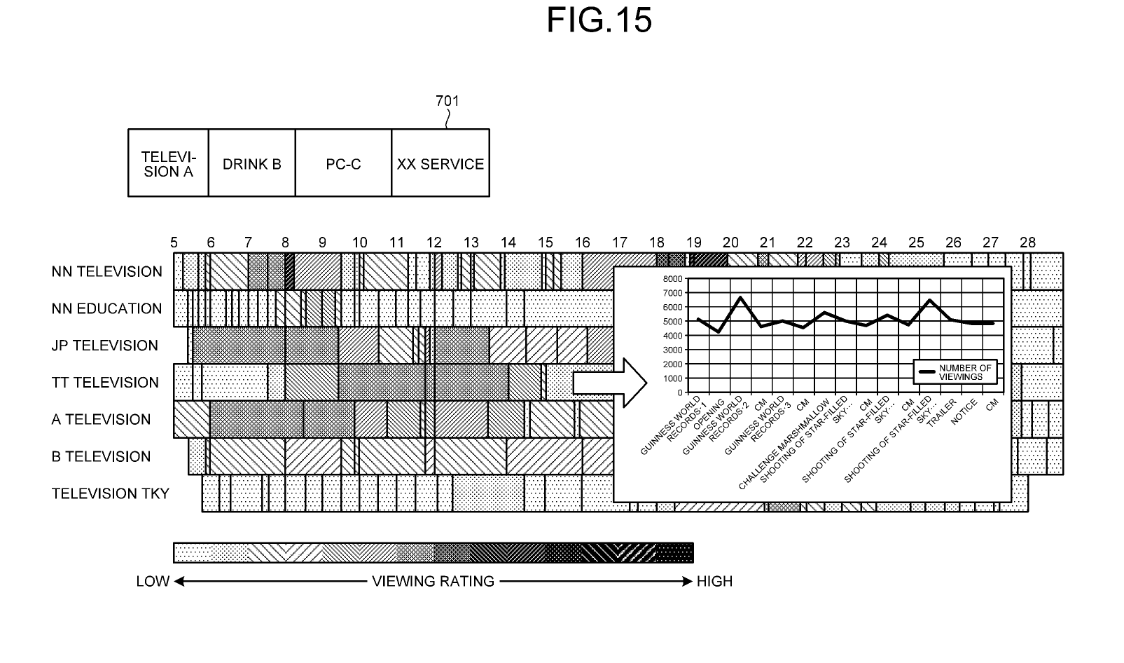

Then, the image processor 403 shapes the extracted data and performs image processing on it at S13 in FIG. 6, and the display controller 404 displays the extracted data on the display device 205 at S14. As a result, as illustrated in FIG. 15, the pieces of viewing information (viewing ratings, the number of viewings) of the scenes and the CMs contained in the program content of the rectangle designated by the user are displayed on the right side. It should be noted that the diagram displayed on the right side in FIG. 15 is the same as the screen of FIG. 11 displayed in the second embodiment.

In the sixth embodiment, when the user designates a specific program content on the display screen of the viewing information, the pieces of viewing information related to the selected program content are displayed based on any time section such as the scene contained in the selected program content or a second. The sixth embodiment, therefore, enables an effect on the action of the viewers of the program content to be analyzed more in detail.

### Seventh Embodiment

In a seventh embodiment, population is further narrowed down to viewers that have viewed a designated program content (specific content) and viewing information in a range of the narrowed population is displayed.

For example, it is assumed that the user designates a rectangle of a specific program content through the input device 206 on the display screen of the viewing information for each piece of action information as illustrated in FIG. 7. In this case, the extraction module 402 narrows down the population to viewers that have viewed the program content of the rectangle designated by the user from the tabulated result data and extracts viewing information at S12 in FIG. 6.

Then, the image processor 403 shapes the extracted data and performs the image processing on it at S13 in FIG. 6, and the display controller 404 displays the extracted data on the display device 205 at S14. As a result, pieces of viewing information of the viewers that have viewed the program content of the rectangle designated by the user are displayed on the right side.

In the seventh embodiment, the population is further narrowed down to the viewers that have viewed a designated program content and the viewing information in a range of the narrowed population is displayed, whereby an effect on the action of the viewers of the program content can be analyzed more in detail.

In the above-mentioned first to seventh embodiments and the modifications, the electronic device 400 maybe configured to inquire at the server 100 and acquire data used when the extraction module 402 of the electronic device 400 performs narrowing and extraction if the data is not contained in the tabulated result data that has been already received.

Although tabulation is performed in the server 100 and extraction from the tabulated result data, the image processing, and the display control are performed in the electronic device 400 in the above-mentioned first to seventh embodiments and the modifications, a dividing manner of these pieces of processing is not limited thereto. For example, the electronic device 400 may be configured so as to perform all the pieces of processing or the tabulation processing. Alternatively, the server 100 and the electronic device 400 can be configured such that the server 100 performs the tabulation, the extraction, and the image processing and transmits viewing data subjected to the image processing to the electronic device 400, and the electronic device 400 displays the viewing data.

Programs that are executed in the server 100 and the electronic device 400 in the first to seventh embodiments are recorded in a computer-readable recording medium such as a compact disc read only memory (CD-ROM), a flexible disk (FD), a compact disc recordable (CD-R), and a digital versatile disc (DVD), as an installable or executable file and provided as a computer program product.

The programs that are executed in the server 100 and the electronic device 400 in the first to seventh embodiments may be stored in a computer connected to a network such as the Internet and provided as a computer program product by being downloaded via the network. The programs that are executed in the server 100 and the electronic device 400 in the embodiment may be provided or distributed as a computer program product via a network such as the Internet.

The programs that are executed in the server 100 and the electronic device 400 in the first to seventh embodiments may be previously embedded in a ROM, for example, and provided as a computer program product.

The programs that are executed in the server 100 and the electronic device 400 in the first to seventh embodiments have a module configuration comprising respective units of the above-mentioned functional blocks. As actual hardware, the CPU 201 reads and executes the programs from the above-mentioned storage medium, so that the above-mentioned respective parts are loaded on the RAM 203 to be generated on the RAM 203.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
a hardware processor configured to:
receive first viewing information relating to viewing a first content item by a set of users, second viewing information relating to viewing a second content item by the set of users, and action information relating to actions performed by at least some of the set of users; and
output information relating to a viewing condition of the first content item and information relating to a viewing condition of the second content item based on a first action by a plurality of users from the set of users, the plurality of users set as a statistical population when the first action is designated.

2. The system of claim 1, wherein the first action comprises at least one of: purchase of a first product, usage of a first service, browsing or usage of a first site, and movement to or remaining in a first area.

3. The system of claim 1, wherein the first action comprises at least one of: viewing the first content item, viewing a plurality of content items of a particular series, and viewing a particular content item a plurality of times.

4. The system of claim 1, wherein the information relating to the viewing condition of the first content item and/or the information relating to the viewing condition of the second content item comprises information distinguishing whether the content item is viewed during live broadcasting or the content item is recorded and viewed after live broadcasting.

5. The system of claim 1, wherein the information relating to the viewing condition of the first content item and/or the information relating to the viewing condition of the second content item comprises information of a difference between a viewing condition for the plurality of users that constitute the statistical population and a viewing condition for each generation of users that constitutes a part of the statistical population.

6. The system of claim 1, wherein when a second area is designated in addition to the first action, the information relating to the viewing condition of the first content item and/or the information relating to the viewing condition of the second content item comprises information relating to a viewing condition for users corresponding to the second area.

7. A method comprising:
receiving first viewing information relating to viewing a first content item by a set of users, second viewing information relating to viewing a second content item by the set of users, and action information relating to actions performed by at least some of the set of users; and
outputting information relating to a viewing condition of the first content item and information relating to a viewing condition of the second content item based on a first action by a plurality of users from the set of users, the plurality of users set as a statistical population when the first action is designated.

8. The method of claim 7, wherein the first action comprises at least one of: purchase of a first product, usage of a first service, browsing or usage of a first site, and movement to or remaining in a first area.

9. The method of claim 7, wherein the first action comprises at least one of: viewing the first content item, viewing a plurality of content items of a particular series, and viewing of a particular content item a plurality of times.

10. The method of claim 7, wherein the information relating to the viewing condition of the first content item and/or the information relating to the viewing condition of the second content item comprises information distinguishing whether the content item is viewed during live broadcasting or the content item is recorded and viewed after live broadcasting.

11. The method of claim 7, wherein the information relating to the viewing condition of the first content item and/or the information relating to the viewing condition of the second content item comprises information of a difference between a viewing condition for the plurality of users that constitute the statistical population and a viewing condition for each generation of users that constitutes a part of the statistical population.

12. The method of claim 7, wherein when a second area is designated in addition to the first action, the information relating to the viewing condition of the first content item and/or the information relating to the viewing condition of the second content item comprises information relating to a viewing condition for users corresponding to the second area.

13. A computer program product including programmed instructions embodied in and stored on a non-transitory computer readable medium, wherein the instructions, when executed by a computer, cause the computer to perform:
receiving first viewing information relating to viewing a first content item by a set of users, second viewing information relating to viewing a second content item by the set of users, and action information relating to actions performed by at least some of the set of users; and
outputting information relating to a viewing condition of the first content item and information relating to a viewing condition of the second content item based on a first action by a plurality of users from the set of users, the plurality of users set as a statistical population when the first action is designated.

14. The computer program product of claim 13, wherein the first action comprises at least one of: purchase of a first product, usage of a first service, browsing or usage of a first site, and movement to or remaining in a first area.

15. The computer program product of claim 13, wherein the first action comprises at least one of: viewing the first content item, viewing a plurality of content items of a particular series, and viewing of a particular content item a plurality of times.

16. The computer program product of claim 13, wherein the information relating to the viewing condition of the first content item and/or the information relating to the viewing condition of the second content item comprises information distinguishing whether the content item is viewed during live broadcasting or the content item is recorded and viewed after live broadcasting.

17. The computer program product of claim 13, wherein the information relating to the viewing condition of the first content item and/or the information relating to the viewing condition of the second content item comprises information of a difference between a viewing condition for the plurality of users that constitute the statistical population and a viewing condition for each generation of users that constitutes a part of the statistical population.

18. The computer program product of claim 13, wherein when a second area is designated in addition to the first action, the information relating to the viewing condition of the first content item and/or the information relating to the viewing condition of the second content item comprises information relating to a viewing condition for users corresponding to the second area.
